(19) United States
(12) Patent Application Publication
(10) Pub. No.: US 2013/0035946 A1
(43) Pub. Date: Feb. 7, 2013

(54) SOCIAL NETWORKS FOR CARE COORDINATION, MANAGEMENT, AND SUPPORT AND HEALTH INFORMATION EXCHANGE

(71) Applicants: Suneel James Ratan, San Francisco, CA (US); Kristen Fisher Ratan, San Francisco, CA (US)

(72) Inventors: Suneel James Ratan, San Francisco, CA (US); Kristen Fisher Ratan, San Francisco, CA (US)

(21) Appl. No.: 13/197,622

(22) Filed: Aug. 3, 2011

(51) Int. Cl. G06Q 50/00; G06Q 99/00

(52) U.S. Cl. 705/2; 705/319

(57) ABSTRACT

Provided are social network based systems and methods for health information sharing and care management and coordination among different groups of individuals and organizations. The systems and methods are particularly useful for care management and coordination for patients having chronic diseases or conditions, including physical and mental illnesses.

### FIELD OF THE DISCLOSURE

The present invention generally relates to the use of secure social networks in the exchange of healthcare information to more effectively coordinate and manage patient care.

### BACKGROUND

Healthcare for individuals with chronic conditions is expensive. In the United States, about 98 percent of Medicare spending is on individuals with one or more chronic conditions. Such leading chronic conditions include heart and pulmonary disease and mental illness.

This spending typically is on elderly and disabled individuals with multiple, complex chronic conditions who, without appropriate care, may end up in institutional long-term care that is very expensive. According to statistics compiled by the Kaiser Family Foundation, the elderly and disabled represent 27 percent of the beneficiaries for the US Medicaid program, which pays for healthcare for the poor (including the elderly and disabled), and account for 70 percent of the program's cost. Fifty-five percent of Medicaid spending is on institutional long-term care.

The current system for providing healthcare and other services to high-cost individuals with chronic conditions, particularly among the elderly and disabled, is fragmented and reactive. Individuals who have multiple, complex chronic conditions are often treated by a multiplicity of physicians and other care professionals and are prescribed a large number of prescription medications. Problems can arise through a lack of coordination of these services and the infrastructure for doing so, such as drug-drug interaction issues for patients who have been prescribed by different physicians in different practices.

In turn, another issue for these high-cost individuals is that there is a broader lack of coordination between healthcare providers and providers of other services—such as in-home nutrition and adult daycare—that address other risk factors relevant to successfully maintaining these individuals in their homes. This broader constellation in turn typically does not communicate systematically with family members who can also support a patient's care. One result is that these individuals, because of the lack of a coordinated network of support, will frequently be taken to emergency rooms and admitted to hospitals, and ultimately require institutional long-term care services.

In recent years, there has been increasing attention paid to models of care coordination and management fix individuals with chronic conditions. There are a number of chronic care models currently being used. Chronic care management encompasses the oversight and education activities conducted by health care professionals to help patients with chronic diseases and health conditions such as diabetes, high blood pressure, lupus, multiple sclerosis and sleep apnea learn to understand their condition and live successfully with it. The work involves motivating patients to persist in necessary therapies and interventions and helping them to achieve an ongoing, reasonable quality of life. In situations where such patient activation is not feasible, these models can encompass some form of monitoring of vital signs and an individual's environment and behavior (particularly with the frail elderly).

One popular chronic care model was developed by Edward H. Wagner, M.D., termed “the Chronic Care Model” or “the Wagner model”. The Wagner model summarizes the basic elements for improving care in health systems on different levels. These elements are the community, the health system, self-management support, delivery system design, decision support and clinical information systems. Evidence-based change concepts under each element, in combination, foster productive interactions between informed patients who take an active part in their care and providers with resources and expertise. The Wagner model can be applied to a variety of chronic illnesses, health care settings and target populations. The bottom line is healthier patients, more satisfied providers, and cost savings. More information about the Wagner model can be found at Wagner EH. (1998) “Chronic disease management: What will it take to improve care for chronic illness? Effective Clinical Practice 1(1):2-4.

The Wagner model attempts to mobilize healthcare, social and aging services, other community resources, and friends and family to better support individuals with chronic conditions. The Wagner model has been shown to work with a high-risk, high-cost population, partly because it is a high-touch interaction model. Questions remain, however, regarding whether this model is cost-effective, scalable, or replicable. There are issues around scalability, particularly in urban underserved areas with some of the greatest need for these kinds of interventions.

Therefore, there is a need for enhancing health information exchange and care management and coordination throughout the community, in particular for high-cost individuals, with an emphasis on the elderly and disabled, with chronic health conditions.

### SUMMARY

This disclosure provides a patient-centric system of care, which is expressed primarily as an information-technology solution, which can be built upon an existing trusted, computerized social network, for care coordination, management and health information exchange to support individuals with chronic conditions.

Thus, the disclosure provides, in one embodiment, a computer-implemented system for coordination or management of healthcare wherein the system is configured to communicate with a social network comprising a patient and a healthcare coordinator and/or a healthcare provider, the system comprising a survey module configured to present to the patient a survey to assess the patient's health condition and, based on the patient's response to the survey, alert the healthcare coordinator and/or the healthcare provider. In one aspect, the patient suffers from a chronic disease or condition.

In one embodiment, the system further comprises a survey question database that comprises one or more questions, each of the questions targets at one or more health conditions. In one aspect, each question is associated with one or more answers and at least one of the answers is tagged with one or more types of healthcare services.

In another embodiment, the survey comprises a set of questions, which set is dynamically generated. In one aspect, generation of a later question in the set is based on the patient's answer to an earlier question in the set. In another aspect, generation of a later question in the set is based on the patient's answer to the preceding question in the set.

In yet another embodiment, the system further comprises a delegate module configured to designate another member of the social network as a patient delegate of the patient, wherein the patient delegate has authorization from the patient to access the patient's personal or medical information and/or communicate with the healthcare coordinator or the healthcare provider on behalf of the patient. In one aspect, the patient delegate is selected from a friend, a family member, a personal caretaker or a healthcare coordinator.

Still in one embodiment, the system further comprises a privacy module configured to ensure that exchange of information concerning the patient through the social network is in compliance with relevant privacy law or regulation. In one aspect, the privacy module assigns a privacy classification to a message sent from each member of the social network.

In one embodiment, the system further comprises a patient interface module configured to allow the patient to interact with the social network. In one aspect, the patient interface is includes the survey.

In another embodiment, the system further comprises a healthcare coordinator interface configured to allow the healthcare coordinator to manage the patient. In one aspect, the healthcare coordinator interface includes health status of the patient and/or alert sent from the patient.

Yet in another embodiment, the system further comprises a scheduling module configured to schedule transportation, check up, doctor's appointment, urgent medical care, and/or pharmacy visit or pickup for the patient. In one aspect, the scheduling module is automatically triggered by a response to the survey.

Still, in one embodiment, the system further comprises an external system for collecting health information from a patient or relevant to the patient's health status. In one aspect, the external system is a measuring and/or monitoring device configured to measure one or more vital signs of the patient.

Also provided, in one embodiment, is a computer-implemented method for sharing healthcare information in a social network, the social network comprising a patient, a delegate and a healthcare service, wherein the delegate has authorization from the patient to (1) access authorized information and/or (2) communicate with the healthcare service on behalf of the patient, the method comprising:

receiving from the patient or the delegate a request to share data;

retrieving the data;

determining one or more members of the social network with which the data can be shared based on (a) the type of the data, (b) the patient's privacy setting on the data and/or (c) the patient's authorization to the member concerning the data; and

sharing the data with the member of the social network.

Further provided in an embodiment is a computer-implemented method for sharing healthcare information in a social network, the social network comprising a patient, a delegate and a healthcare service, wherein the delegate has authorization from the patient to (1) access authorized information and/or (2) communicate with the healthcare service on behalf of the patient, the method comprising:

receiving from the healthcare service a request to share data;

retrieving the data;

determining whether the delegate has authorization to receive the data based on (a) the type of the data, (b) the patient's privacy setting on the data and/or (c) the patient's authorization to the delegate concerning the data; and

sharing the data with the delegate if the delegate has authorization to receive the data.

Computer program product and computer systems for implementing the above methods are also provided.

In one aspect, the patient suffers from a chronic disease or condition. In another aspect, the healthcare service comprises one or more of a care coordinator, a healthcare system, a social worker, an insurer, a supportive service provider, a family member or a friend. Still in another aspect, the delegate is selected from a friend, a family member, a personal caretaker or a healthcare service.

In some aspects, the authorization can be changed by the patient at any time or where the authorization cannot be changed by the patient after the initial authorization. In some aspects, the authorized information includes all information of the patient. In one aspect, the authorized information includes partial information of the patient.

In some embodiments, the request is from the patient, from the delegate, or from the healthcare service. In one aspect, the data include input from the patient or the delegate, such as data retrieved from an external system, including but not limited to an electronic medical record system or a personal electronic device.

In one aspect, the data comprise measurements of the patient's health condition, request for analysis and/or request for medical attention or advice.

In yet another aspect, the data are stored in the social network for access by the members. In another aspect, the data are transmitted to the members. Still further, in one aspect, the receiving, retrieving and/or sharing is carried out through secure data communication.

### BRIEF DESCRIPTION OF THE DRAWINGS

Provided embodiments are illustrated by way of example, and not limitation, in the figures of the accompanying drawings in which:

FIG. 1 illustrates a social network based information exchange and care coordination and management network for patients;

FIG. 2 presents a relationship and communication flow overview of the social network;

FIG. 3 illustrates a care management node (subnetwork);

FIG. 4 illustrates a family/friends node;

FIG. 5 exemplifies a care network establishment;

FIG. 6A-F show exemplary system architectures of the social network (overview in A), with B presenting a patient interview view, C presenting a care coordinator view, D presenting a remote caregiver delegate view, E illustrating a system architecture—server/database relationships, and F showing the included databases and working modules;

FIG. 7 illustrates a patient neighborhood profile;

FIG. 8 is an exemplary patient view that includes a survey panel on the left;

FIG. 9 is an exemplary survey questionnaire;

FIG. 10 illustrates how a referral is generated by the network based on the survey result;

FIG. 11 illustrates the workflow of a network-generated referral based on the survey result;

FIG. 12 us tes a care coordinator management interface for referral management;

FIG. 13 illustrates a care coordinator management interface at a patient level;

FIG. 14 illustrates a care provider management interface for referral management;

FIG. 15 illustrates a patient management interface for referral management; and

FIG. 16 shows an user authentication and reminder interface that enhances privacy-law compliance,

It will be recognized that some or all of the figures are schematic representations for purposes of illustration and do not necessarily depict the actual relative sizes or locations of the elements shown. The figures are provided for the purpose of illustrating one or more embodiments with the explicit understanding that they will not be used to limit the scope or the meaning of the claims.

### DETAILED DESCRIPTION

As used herein, certain terms have the following defined meanings. Terms that are not defined have their art recognized meanings.

As used in the specification and claims, the singular form “a”, “an” and “the” include plural references unless the context clearly dictates otherwise.

As used herein, the term “comprising” is intended to mean that the components, systems and methods include the recited elements, but not excluding others. “Consisting essentially of” when used to define components, systems and methods, shall mean excluding other elements that would materially affect the basic and novel characteristics of the disclosure. “Consisting of” shall mean excluding any element, step, or component not specified in the claim. Embodiments defined by each of these transition terms are within the scope of this disclosure.

A “social network” refers to a social structure, implemented over a computer network, that is made up of individuals or organizations, which are connected by one or more specific types of interdependency, such as, but not limited to, friendship, kinship, common interest, financial exchange, like/dislike, sexual relationships, or relationships of beliefs, knowledge or prestige.

A “patient” is synonymous with an individual and is intended to be non-limiting in scope. However, in one embodiment, the term “patient” intends an individual who is under medical care or treatment. In an alternative embodiment, a patient is an individual who desires to receive medical care or related information, or yet further, an individual who shows general attention to its health status or care.

A “computer network”, as used herein, refers to a collection of computers and devices interconnected by communications channels that facilitate communications and allows sharing of resources and information among interconnected devices. Non-limiting examples of devices include any electronic device capable of transmitting an electronic signal to another device, such as tablets, smart phones and regular cell phones.

A “computer” intends a programmable machine designed to sequentially and automatically carry out a sequence of arithmetic or logical operations. A computer can consist of some form of memory for data storage, at least one element that carries out arithmetic and logic operations, and a sequencing and control element that can change the order of operations based on the information that is stored. A computer can also contain a processing unit, a “processor”, that executes series of instructions that make it read, manipulate and then store data.

A “processor” is an electronic circuit that can execute computer programs. Examples of processors include, but are not limited to, central processing units, microprocessors, graphics processing units, physics processing units, digital signal processors, network processors, front end processors, coprocessors, data processors and audio processors.

A “memory” refers to an electrical device that stores data for retrieval. In one aspect, a memory is a computer unit that preserves data and assists computation.

A “storage medium” or “data storage device” refers to a device for recording information. Recording can be done using virtually any form of energy, spanning from manual muscle power in handwriting, to acoustic vibrations in phonographic recording, to electromagnetic energy modulating magnetic tape and optical discs. In one aspect, a storage medium is a computer hard drive. In another aspect, a storage medium is a computer memory. In yet another aspect, a storage medium is a flash drive for a portable or wireless computing device.

A “healthcare service” refers to any individual or organization that provides healthcare information, coordination, management and services. Non-limiting examples of healthcare services include healthcare coordinators, healthcare providers, healthcare systems and teams, social workers, supportive services and teams, informal caregivers, insurers, and family and friends.

### DETAILS OF THE DISCLOSURE

The present technology uses social-networking and other virtual-care technologies to strengthen or create networks of support for individuals, in particular those with complex chronic conditions, the disabled, and the elderly. Moreover, the present technology uses social networking to transition the healthcare system from one that is institutionally based to one that is networked and distributed. Therefore, in terms of providing healthcare to any needed individual, the present technology is more cost-effective and scalable; while offering at least similar levels of secure privacy protection.

Although this system is described in conjunction with the delivery of health care services and related supportive services for the elderly, disabled, and others with chronic conditions, it is contemplated by the Applicant that the elements of this disclosure are applicable to any system wherein delegated access to personal or sensitive information within a social network is desirable, e.g., remote access and management of sensitive technical or financial information. Thus, unless specifically defined otherwise, the elements of this disclosure can be broadly applied to other similar systems and methods for the management of sensitive information and data.

Interlocking social networks, intended as a basis for successful management of a chronic condition and for maintaining an individual in independent living outside of acute-care and long-term care settings are maintained. The interlocking social networks connect individuals with professional caregivers who work for healthcare and community organizations, informal caregivers such as family and friends, and other individuals with chronic conditions.

Care organizations—healthcare, social services, or other community organizations—can define care networks and invite organizations to join in a manner that facilitates the exchange of protected personal health information. Individuals are also able to register and to establish the interlocking networks either on their own or in conjunction with a professional or family caregiver. Individuals are able to determine the nature and quality of information viewable by one or more of the interlocking networks.

In addition, the care provider can access through other existing networks information that is relevant to the patient's ongoing care, such as accessibility to other support networks, including hospital and acute care facilities, as well as proximity to health risk factors such as waste management locations and proximity to disease clusters. This additional information can be unappreciated by the patient yet germane to the patient's on-going diagnosis, prognosis and treatment. The system conforms to privacy laws through a permission-based mechanism for individuals within the interlocking networks to gain access to and exchange any Personal Health Information (PHI as defined under the US Health Insurance Portability and Accountability Act).

The system includes mechanisms for delegated professional and family caregivers to interact with individuals supported via the system, both through means such as automated surveys and delivery of media content and through secure one- or two-way messaging using functionality of an existing trusted network (such as Facebook or Google+), including messaging within the confines of the system, as well as by e-mail, text messaging, and text-to-speech voice communications, interactive voice response, interactive video chat, and/or human-to-human telephonic interactions.

Thus, in one aspect the present disclosure provides a social network based systems and methods for health information sharing and care management and coordination among different groups of individuals and organizations. The systems and methods ensure that the information exchange is in compliance with local, state, and federal law and regulation, such as the United States Health Insurance Portability and Accountability Act (HIPAA). Further, for patients that do not have direct access to the social network, that do not have the capacity to carry out information exchange such as those physically or mentally disabled, or that prefer to have a family member, friend, or informal care provider to serve as an intermediate, the systems and methods also provide a delegate role to those individuals or organizations are authorized by the patients.

In one aspect, therefore, the systems and methods of the present disclosure provide a social network between patients as well their delegates, healthcare coordinators and healthcare providers to facilitate health information exchange and care management while maintaining appropriate privacy for the patients.

In another aspect, the systems and methods provide connections among patients so that they can share information among themselves. Such connections may be disease-oriented or location-based, among other possibilities.

In yet another aspect, any of the networks described herein can be interconnected which then maximizes information sharing while observing proper privacy boundaries.

The present technology is apparently different from other means of implementing the Wagner model for chronic care management, which consists of a care coordinator that interacts with healthcare teams, community services and informal caregivers and coordinates their activities and services for a patient. The patient, however, interacts with the care coordinator only, or in some cases, also with an informal caregiver. Here, the model is centered on the care coordinator. Information exchange among other members of the model is therefore indirect, limited, and fragmented. For instance, the healthcare team may not be aware of care already provided to the patient by the informal caregiver or the community services. The informal caregiver and the community services, on the other hand, may not have access to useful information of the patient possessed by the healthcare team. Additionally, the fragmentation of information exchange increases costs in the care system.

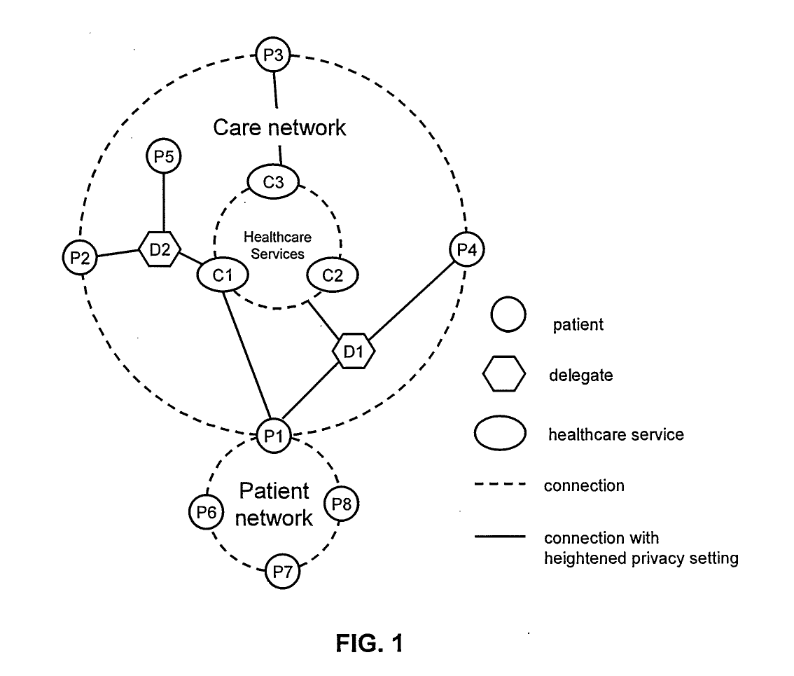

FIG. 1 illustrates a general social network on which the present technology can be implemented. In particular, FIG. 1 includes members named “delegates” and edges that can be dotted or solid, representing communication with different privacy settings. The advantages of these are described in detail below.

### Delegates

It is contemplated that some patients, in particular those with physical or mental disabilities, may not be able to or willing to sign up or use a computer network-based social network. To this end, the present technology, as illustrated in FIG. 1, provides to such a patient (P5) a patient delegate or delegate (D2). P5 can simply give his or her permission for supportive resources to D2, who can be, for instance, a clinician, a home care agency or individual, a social worker, or a friend or family member, D2 then can interact with other members of the social network on behalf of P5 to obtain healthcare support.

When a patient is not directly connected to the social network, the patient can, in any event, still communicate with the delegate by any means known in the art, including, for instance, phone call, face-to-face communication, text messaging, instant messaging, or other social networking tools.

In another aspect, even if the patient is directly connected to other members of the social network beside the delegate, the patient can still, from time to time, choose to share or receive information through the delegate. This is useful in particular when the patient's condition is unstable or they otherwise lack any means to access the social network. In some aspects, the delegate, such as a community services professional or an informal caregiver, is better suited to provide an accurate assessment of the patient's condition to be shared on the network than the patient. With reference to FIG. 1, patient P1 is directly connected to healthcare service C1, and is also indirectly connected to the entire healthcare service network through delegate D1. Patient D4, on the other hand, only connects to the healthcare service network through delegate D1, but maintains connections with other patients in the network.

In one aspect, the delegate is selected from a friend, a family member, a personal caretaker or a healthcare service. In one aspect, the authorization given by a patient to the delegate can be changed by the patient at any time. In another aspect, such authorization cannot be changed by the patient after the initial authorization. In some aspects, the delegate can be an individual or an organization.

Authorization to a delegate can be complete authorization such that the delegate has access to all of the patient's information, or partial authorization, in which case, the delegate only has access to some of the patient's information, the authorized information.

### Members and Nodes of the Network

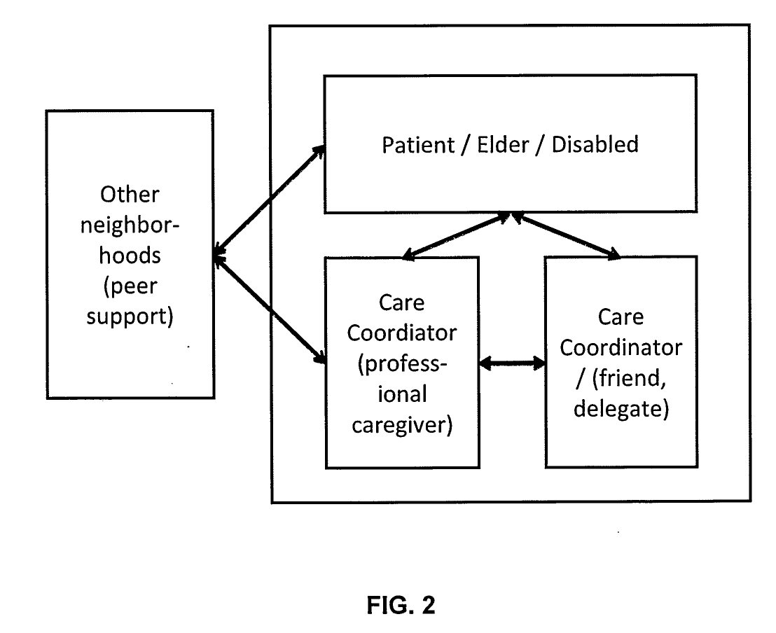

In some aspect, a healthcare coordinator (or “neighborhood manager”) is provided, which can be a professional caregiver (nurse, physician, social worker, home health aid. Alternatively, the care coordinator can be an informal caregiver such as an adult offspring, other family members, friends, or neighbors. Referring to FIG. 2, the patient is connected to either a care coordinator that is a professional caregiver, or a care coordinator that is a family member or friend, or both. Such a sub-network can serve as a node in the overall network. FIG. 2 therefore exemplifies some key nodes in the care neighborhood social network. For the purposes of coordinating care, inter-nodal communications can mainly take place between the principal nodes.

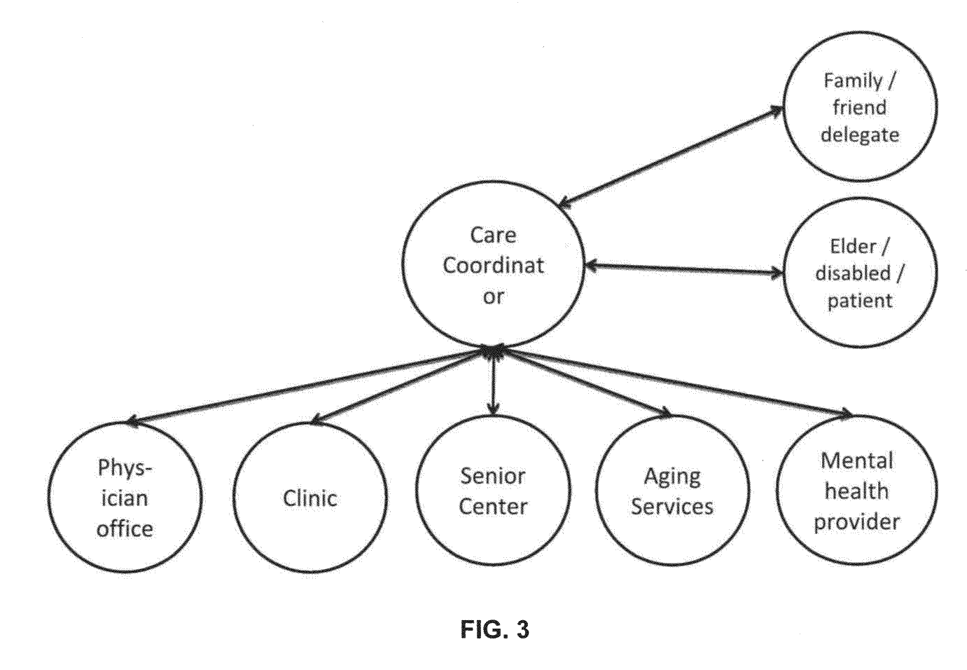

The care coordinators can then connect to other members of the social network, such as physician offices, clinics, senior centers, aging services, and mental healthcare providers (FIG. 3). In this respect, a professional care coordinator can gate keep (within social network) interactions between the patient and family delegate, and network of other professional caregivers. A family member or friend can also manage a patient's network in the absence of a professional caregiver, or if an individual chooses to otherwise have a family member or friend play that role.

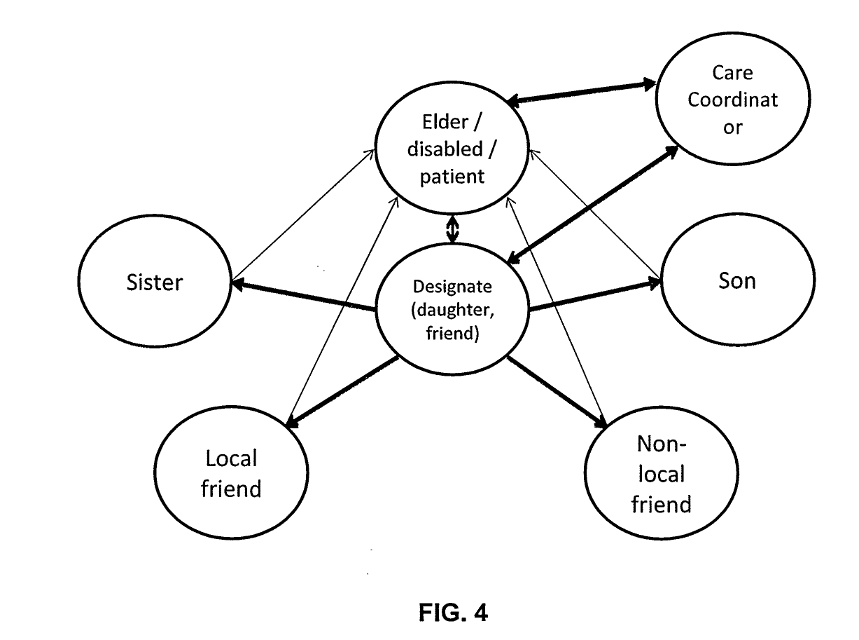

Besides connecting to one or more care coordinators, the patient can also connect to family members, friends, acquaintances, neighbors, fellow patients to form a family/friend node, as illustrated in FIG. 4. In this node, the family/friend delegate is a gate keeper for information specifically related to mobilizing informal caregivers in the care and support of a patient. Non delegate family members and friends, on the other hand, can post non-care-related messages (such as birthdays wishes, updates about grandchildren, photos) without delegate approval.

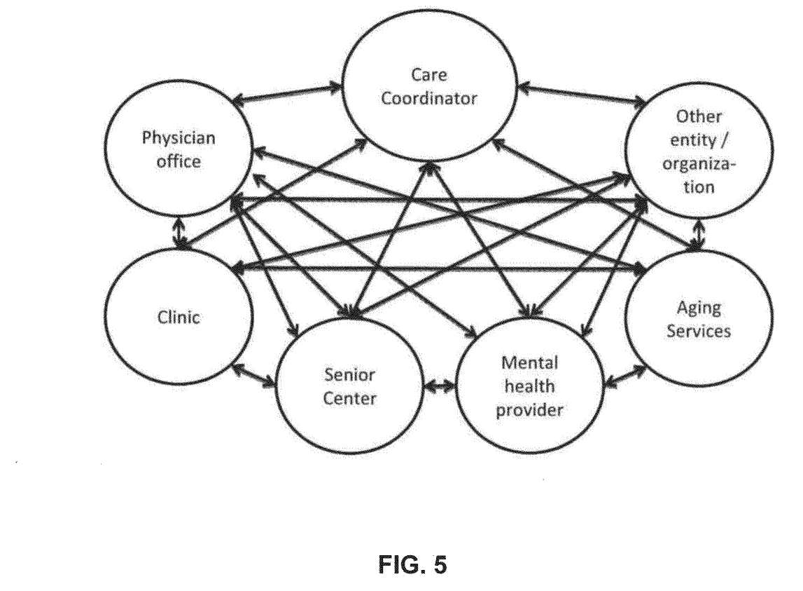

In the present technology, all members and nodes of a professional caregiving sub-network are interconnected, as illustrated in FIG. 5. Without being limited by theory, FIG. 5 further suggests, as a first step, an organization establishes a local care network (“the care neighborhood”). It can then electronically invite other organizations to join the network, with a computer- and network-based process in which an organization that joins agrees to share private health information with other organizations and comply with privacy laws. Organizations already participating on the network can be invited to join individual neighborhoods. Alternatively, a care neighborhood can be first established by a patient, a patient delegate, or a care coordinator, and then the first members invite others to join their networks.

### Systems to Implement the Network

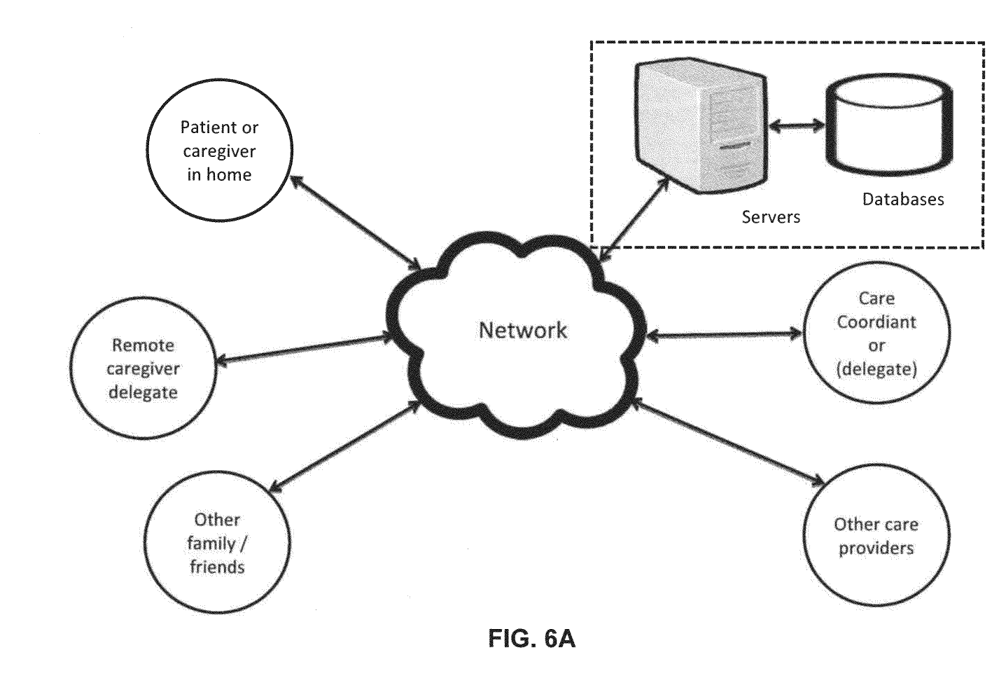

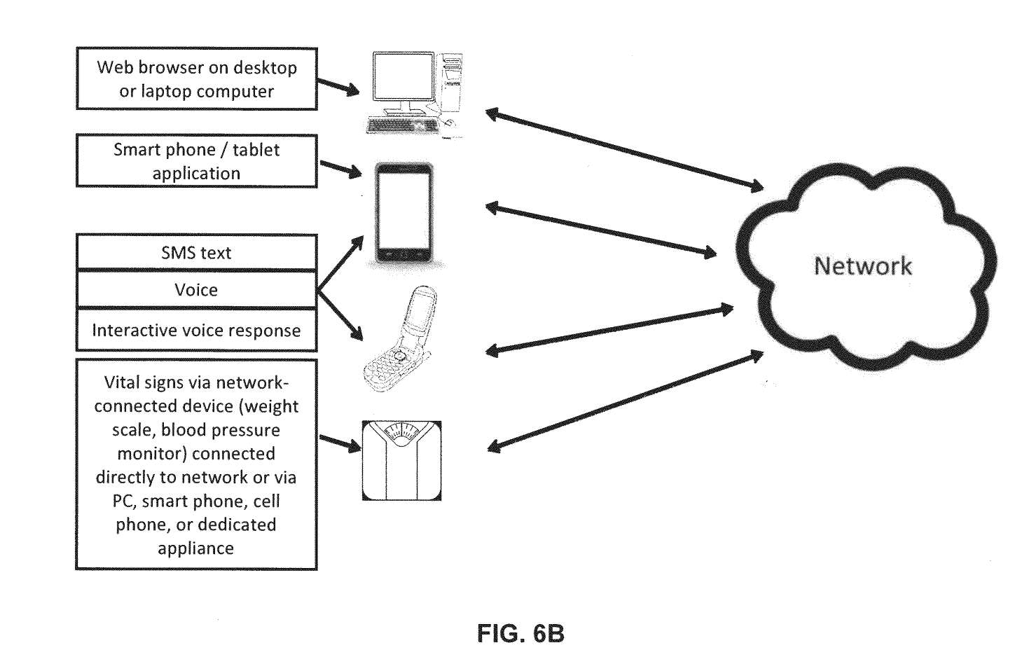

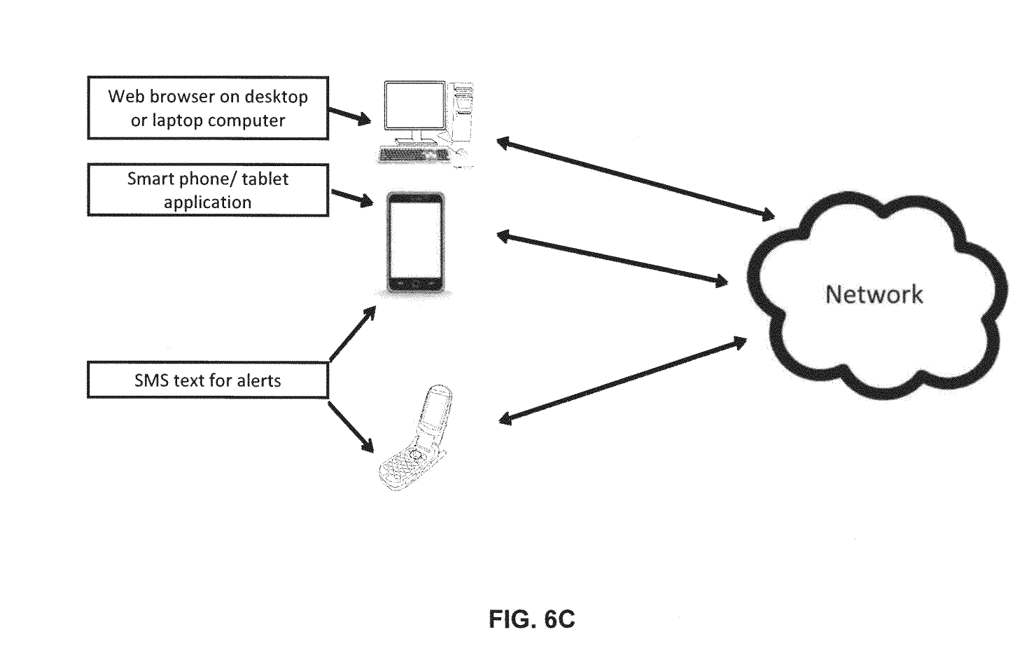

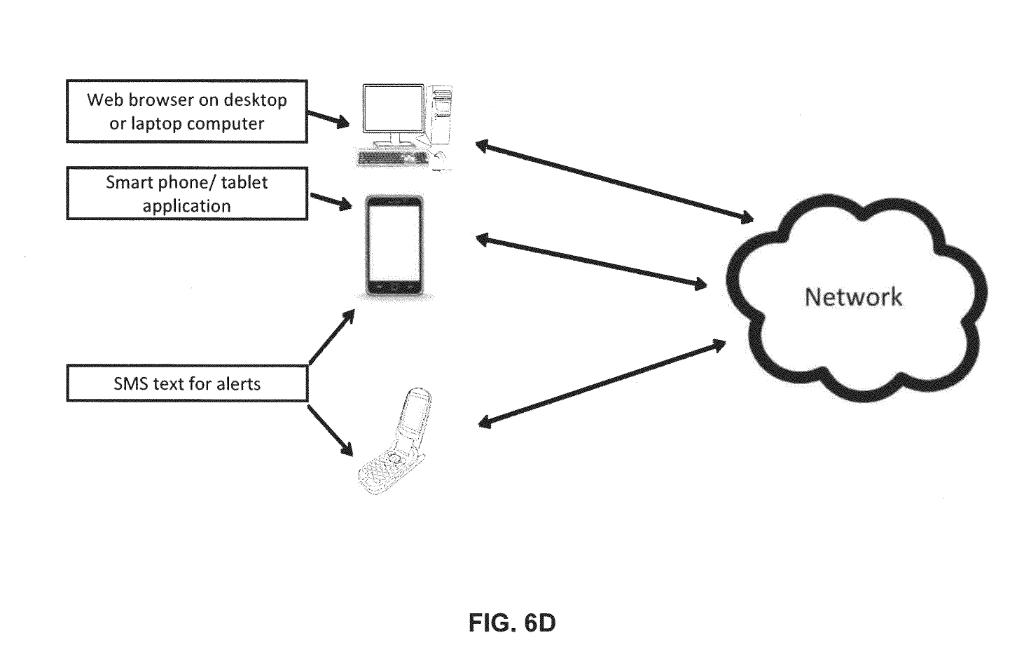

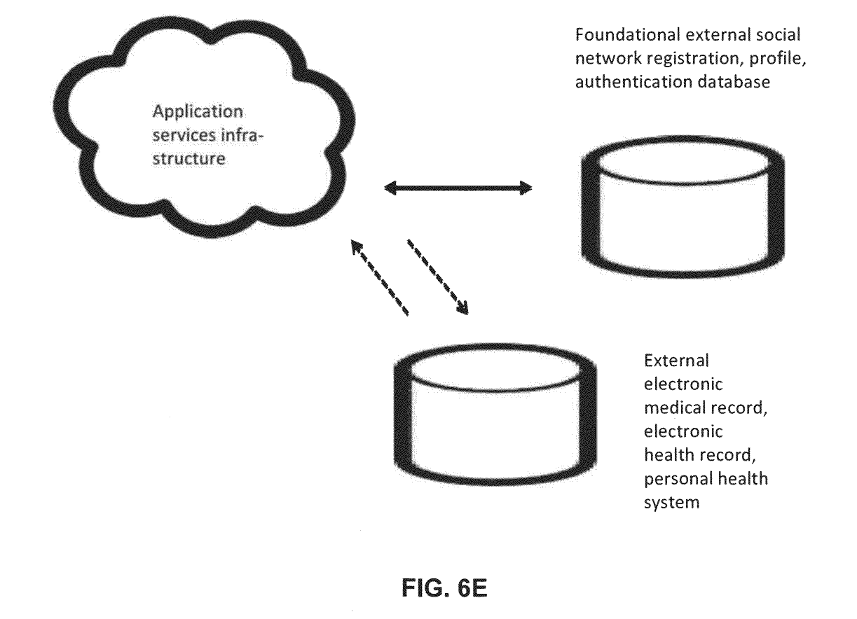

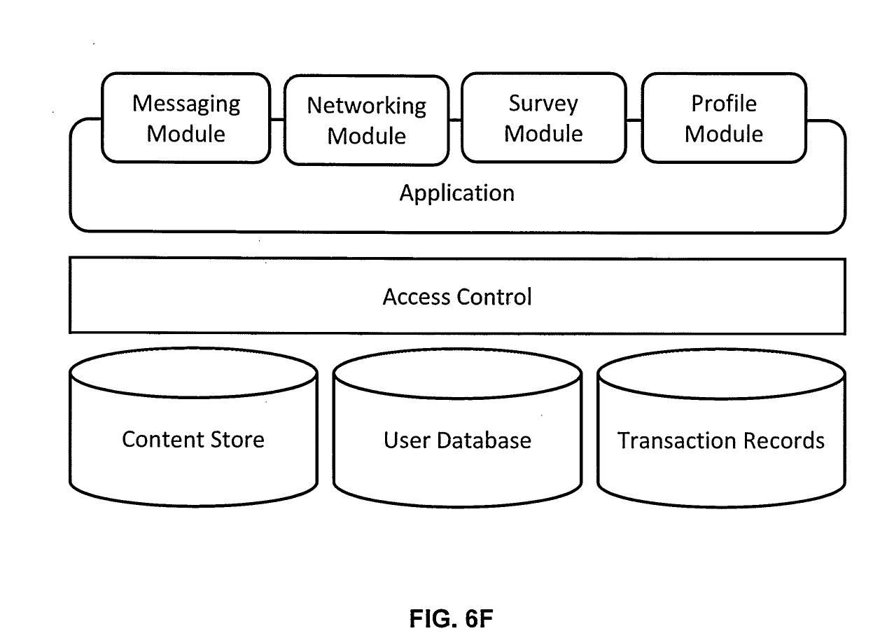

Systems and methods of implementing the network are also contemplated. FIG. 6A-6E exemplifies some of these systems and methods. For instance, FIG. 6A illustrates a computer network comprised of computer servers and databases. Such a network, as described above, includes connections to patients, family and friends, care coordinators, remote caregiver delegates and other caregivers and provides interfaces to each of these network members.

The interface for a patient., for instance, can be a web browser on a desktop or laptop computer or an application on a smart phone or tablet, or mediated by SMS text message, voice message, interactive voice responses and the like. In one aspect., the interface can include a measuring device that is connected to the network (FIG. 6B). The measuring device measures vital signs, such as weight, blood pressure, and transmits the measuring results directly to the network, or indirectly via a computer or a smart phone.

Interaction with a care coordinator can take place at a web browser or on a smart phone. Text messages and voice communications can also be means of such interaction or further supplement the interaction (FIG. 6C). For instance, a care coordinator can receive a text message from the network that relates to a medical condition of a patient that the manager manages, e.g., “Mrs. Smith needs help now, please call xxx-xxx-xxxx.” Similar interfaces and alerting services can be implemented for a remote caregiver that serves as a delegate (see FIG. 6D).

### Databases

At the content level, the network can include data similar to or retrieved from external electronic medical records, electronic health records and/or personal health record systems (FIG. 6E). At the system level, the database of the network can be configured to include a content store, a user database and a transaction record database (FIG. 6F).

The content store can include information falling into any of the following categories: patient medical records, lab reports, communications, patient care content, assessments (surveys) and templates. All content can have metadata assigned such as author, date/time stamps, category, and patient name.

The user database can include information about users such as patients, caregivers, care coordinators, physicians, physician assistants, community services, mental health services, lab and can be configured to generate reports on the users.

The transaction record database includes logs of any or more of the following transactions: referrals, assignments, information sharing, uploads, downloads, communications, status updates and can also be configured to generate reports on these transactions.

In some aspects, access control is implemented in the network. Permission for each user to certain content and transactions can be set up. In this respect, each user is assigned to one or more roles and each role is granted permission to read only or write/edit authority for certain categories of content or individual content items. In the same vein, each role can be granted permission to read only or write edit authority for categories of transactions or individual transactions.

### Privacy Settings

Further, the present disclosure also contemplates secure information exchange among members of the social network and privacy settings that are in compliance with local, state and federal laws and regulations and that respect the patient's privacy preferences. To achieve this, in one aspect, all healthcare services in a patient's network are categorized. For instance, a healthcare team can have a highest privacy setting allowing it to access all of the patient's medical data. A non-medical professional caregiver, on the other hand, may have a relatively lower privacy setting that only gives it access to non-health-related information such as the patient's location, contact information (for both the individual and the delegate informal caregiver), online schedule. In the same vein, another patient that is in this patient's network may have the lowest privacy setting. Privacy settings can be based either on the category of the provider (i.e. healthcare vs. non-healthcare-related services), or assigned specifically to individual organizations or informal caregivers (more than one family member may be given access to privacy-law-protected personal health information). Such categorization may be changed by the patient or the patient's delegate.

In another aspect, when a delegate is generated in the network for a patient, the patient can authorize the delegate to access certain information of the patient, and can authorize the delegate to act on certain matters on behalf of the patient. Such authorization can be adjusted or even terminated at any time by the patient or their delegate, unless the patient is terminating the relationship with the delegate, such as a delegate organization.

Still in another aspect, when a user, e.g., a patient or a delegate, requests to share data with any member of the network, the system will assess the privacy level of the data and determine what members of the network to which the data can be shared.

In one aspect, the privacy level depends on the type of data. For instance, while entering the data or retrieving the data from an external resource, the system can ask the user or their delegate to classify the data. Classification of the data can include, without limitation, prescription information, medical history, symptom, insurance information, financial arrangement, pandemic alert, or general healthcare question. Prescription information and medical history, for instance, are private data that can only be shared with healthcare services but not with other patients. Insurance, medical claims, and other financial, on the other hand, can have even higher privacy setting that only allows access to care coordinators. Further, pandemic alerts and general questions may be suitable for sharing with any member on the network.

It is contemplated that classification of the data does not have to be entered by the user. Instead, there are a wide range of machine learning approaches suitable for automated classification of information, such as using keyword matching, in particular along with an appropriate, expert generated vocabulary.

In another aspect, the user can specify the privacy setting for each data. The specification can be one time, or pre-determined in the user's preference profile. This specific privacy setting may override the privacy setting inferred from the classification of the data. For example, although medical history is generally accessible to a care coordinator, the user may elect to permit access to the medical history to a healthcare professional or team only.

In yet another aspect, the user can grant specific authorization for access to the data to certain members on the network. Such authorization can be group based, for instance, to all community services, or individual member based, for instance, to any specific member.

Still in another aspect, the privacy settings of the present technology ensure that the information exchange is in compliance with local, state, and federal law and regulation, such as the United States Health Insurance Portability and Accountability Act (HIPAA).

The United State Health Insurance Portability and Accountability Act (HIPAA) was enacted by the U.S. Congress in 1996, The Administration Simplification provisions of HIPAA address the security and privacy of health data. The standards are meant to improve the efficiency and effectiveness of the nation's health care system by encouraging the widespread use of electronic data interchange in the U.S. health care system. Title II of HIPAA defines numerous offenses relating to health care and sets civil and criminal penalties for them. It also creates several programs to control fraud and abuse within the health care system. Per the requirements of Title II, the Department of Health and Human Services (HHS) has promulgated five rules regarding Administrative Simplification: the Privacy Rule, the Transactions and Code Sets Rule, the Security Rule, the Unique identifiers Rule, and the Enforcement Rule.

The HIPAA Privacy Rule regulates the use and disclosure of certain information held by “covered entities” (generally, health care clearinghouses, employer sponsored health plans, health insurers, and medical service providers that engage in certain transactions). It establishes regulations for the use and disclosure of Protected Health Information (PHI). PHI is any information held by a covered entity which concerns health status, provision of health care, or payment for health care that can be linked to an individual. This is interpreted rather broadly and includes any part of an individual's medical record or payment history.

A covered entity may disclose PHI to facilitate treatment, payment, or health care operations, or if the covered entity has obtained authorization from the individual. However, when a covered entity discloses any PHI, it must make a reasonable effort to disclose only the minimum necessary information required to achieve its purpose.

The Privacy Rule gives individuals the right to request that a covered entity correct any inaccurate PHI. It also requires covered entities to take reasonable steps to ensure the confidentiality of communications with individuals. For example, an individual can ask to be called at his or her work number, instead of home or cell phone number.

The Privacy Rule requires covered entities to notify individuals of uses of their PHI. Covered entities must also keep track of disclosures of PHI and document privacy policies and procedures. They must appoint a Privacy Official and a contact person responsible for receiving complaints and train all members of their workforce in procedures regarding PHI.

Accordingly, the social network of the present disclosure includes a mechanism to enforce compliance to HIPPA. In one aspect, any member on the network will be classified as covered entity or non-covered entity. Special rules apply to those covered entities, such as insurers and healthcare team or physicians.

In another aspect, all information exchanged on the social network is examined with respect to whether such information is PHI. Any information classified as PHI will have special privacy setting to be in compliance with the law.

### Working Modules

The network can also contain an application layer that includes a number of working modules which can include one or more of the following: registration module, profile module, authentication module, messaging module, network module, scheduling module, and survey module (FIG. 6E).

The authentication module, for instance, carries out authentication for the network members. For an organization such as a care provider, authentication can be implemented based on IP range access (any user coming from the IP addresses assigned at the institution can have access to the system), using username/password, or by proxy access which enables known offsite locations to have proxy access at the same level as the institution. Individuals, on the other hand, can use username/password, or simply be authenticated with their credentials from another existing social network (such as Facebook or Google+). It is contemplated that system access does not automatically grant access to individual pieces of content or authority to perform transactions.

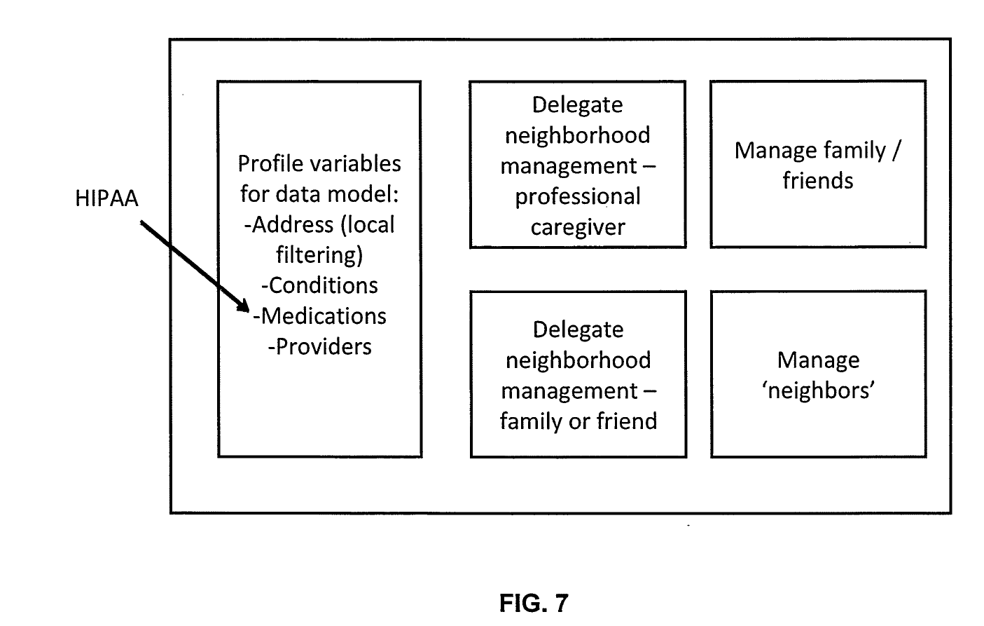

The profile module, as illustrated in FIG. 7, manages a user's information as well as its neighborhood. A patient's profile can include the patient's personal information, such as address, conditions, medications and care providers, all of which may be subject to privacy law regulation. Other information in a patient's profile includes the patient's delegates, family and friends and network neighbors (FIG. 7).

### Working Modules—Survey, Referral and Scheduling

In one embodiment, the network includes a survey module that enables collection of useful patient information, and in case necessary, provides automatic referral to appropriate healthcare services,

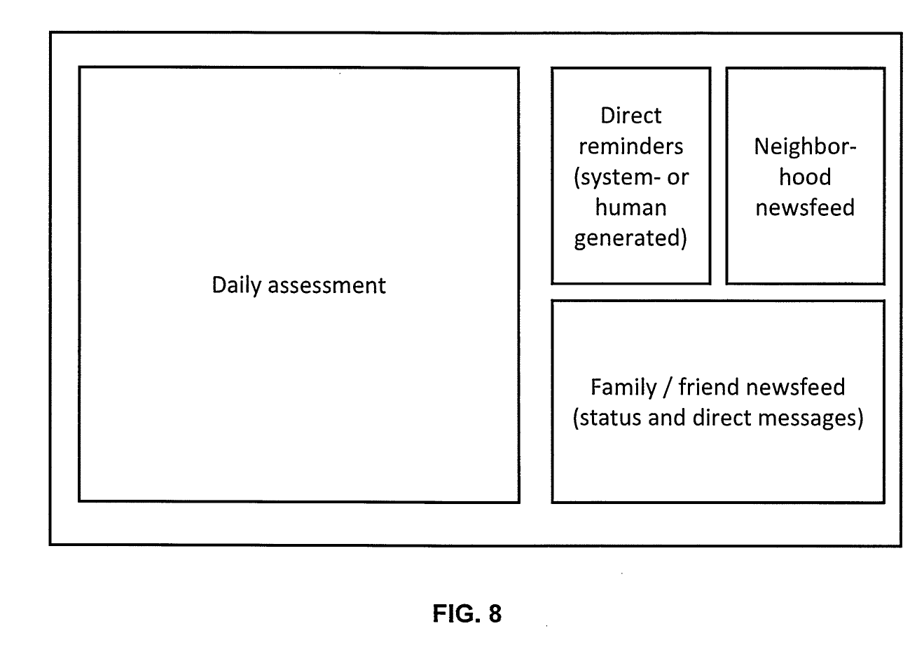

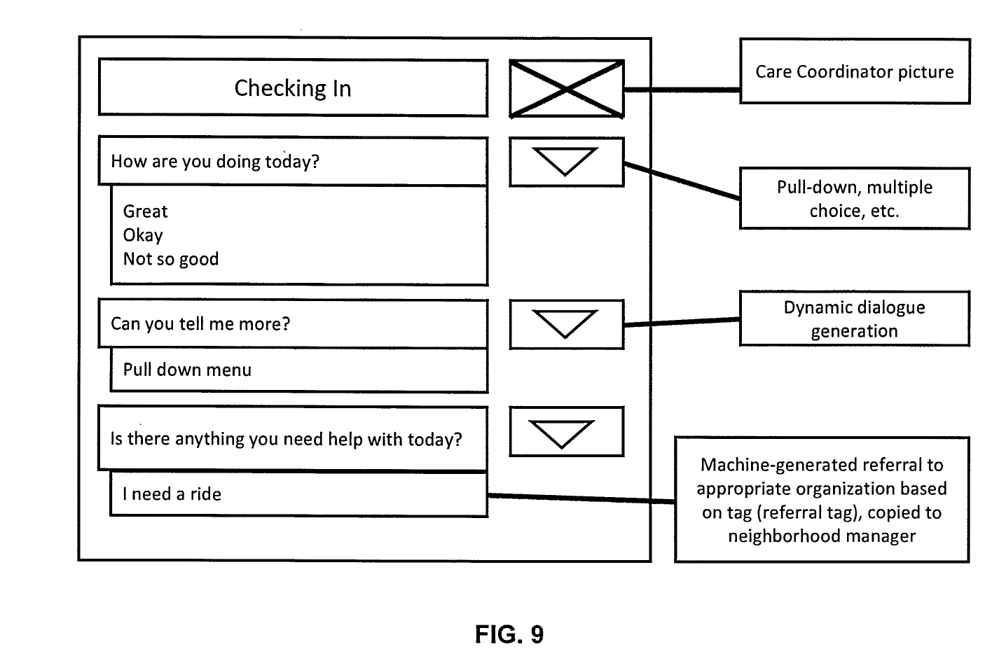

When a patient logs into the network, in one embodiment, the patient is presented with an interface (FIG. 8) that includes a daily survey (daily assessment). In one aspect, the survey is automatically or dynamically generated from a database that includes a variety of questions tailored to assess a patient's health condition. The questions can be general or specific to a particular disease or condition. Further, arrangement of the questions can be tailored to facilitate retrieval of health information based on the patient's answers to previous questions (see FIG. 9).

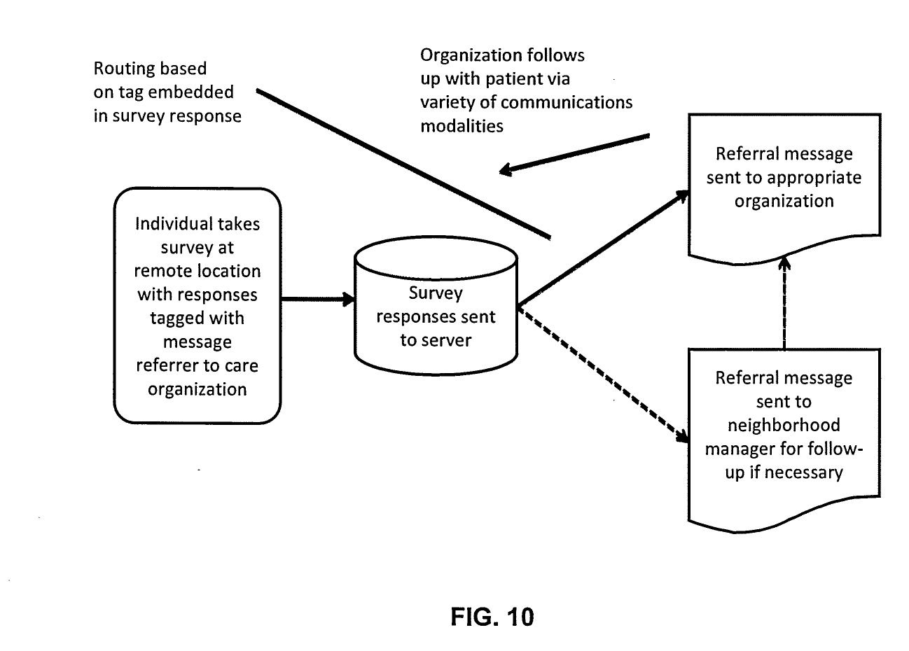

Answers collected from the survey can then be subject to analysis and routing. In this respect, based on automated surveys, each multiple-choice response to a question is tagged with a referrer to an organization. Hence, based on the response to a question or questions, an alert message can be sent directly to relevant care provider. Such an alert or referral can also be specified in professional care coordinator view (FIG. 10). For example, when a patient, Mrs. Jones, or her family delegate, is asked how her mood is, with a number of multiple-choice responses, if she picks, “Feeling down today,” she can be prompted to the next question, “How long have you had such a feeling?” If her response is “Five days,” then a message is directly sent to the mental health provider in her network and copied to her care coordinator. For the care coordinator, appropriate interfaces are provided to enable managing and resolving referrals, including automated reminders for an organization to follow up on the referral.

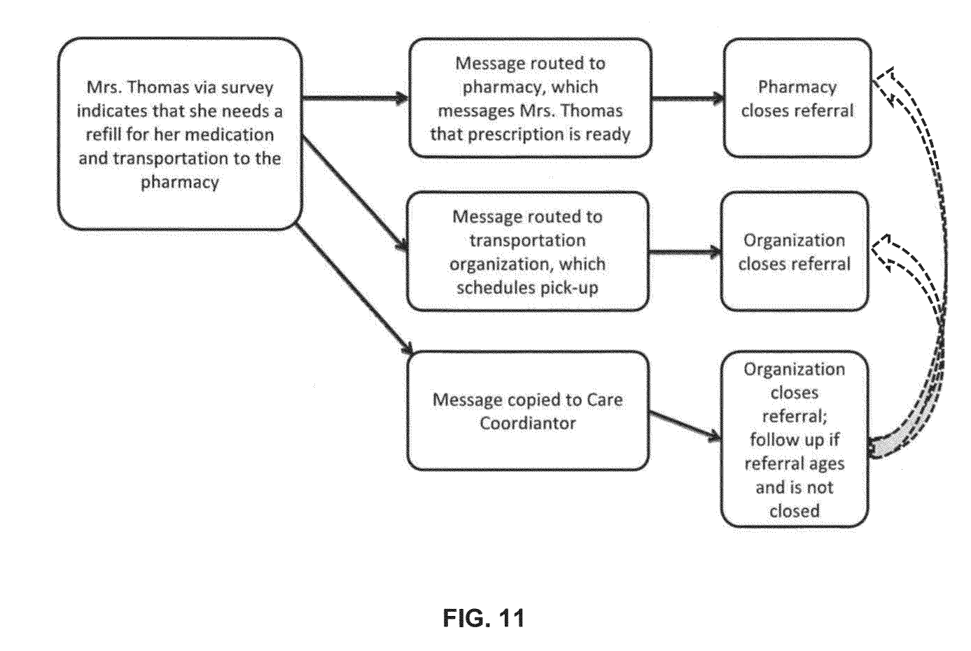

FIG. 11 shows another example, in which Mrs. Thomas, in response to a survey question, indicates a need for a refill of her medication and transportation to the pharmacy. The network then routes a message to the pharmacy, which will prepare the refill and then sends a message back to Mrs. Thomas that the refill is ready for pickup. Meanwhile, the network routes a message to a transportation organization that will schedule transportation to the pharmacy for Mrs. Thomas. All such messages are also copied to Mrs. Thomas' delegated care coordinator, who will ensure proper execution of each of the actions.

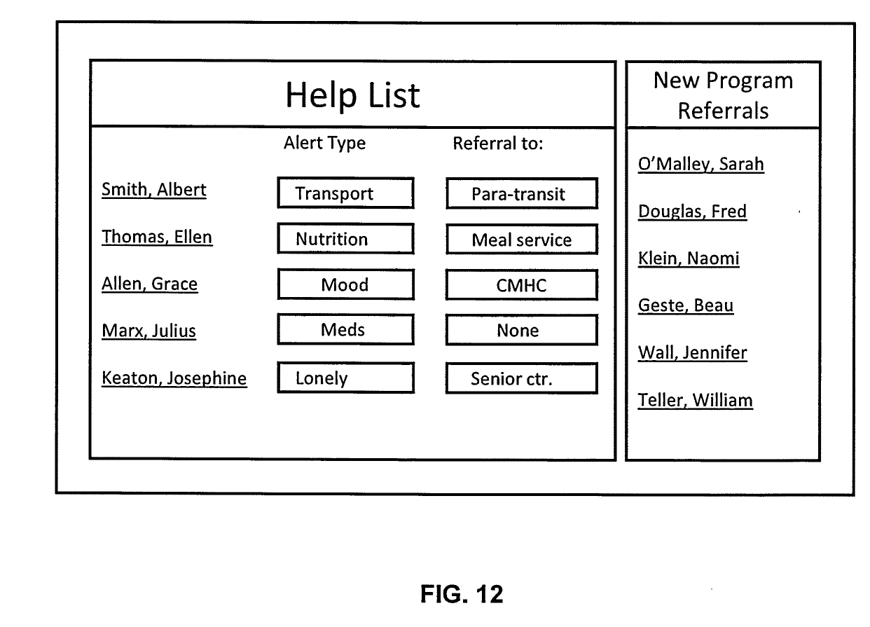

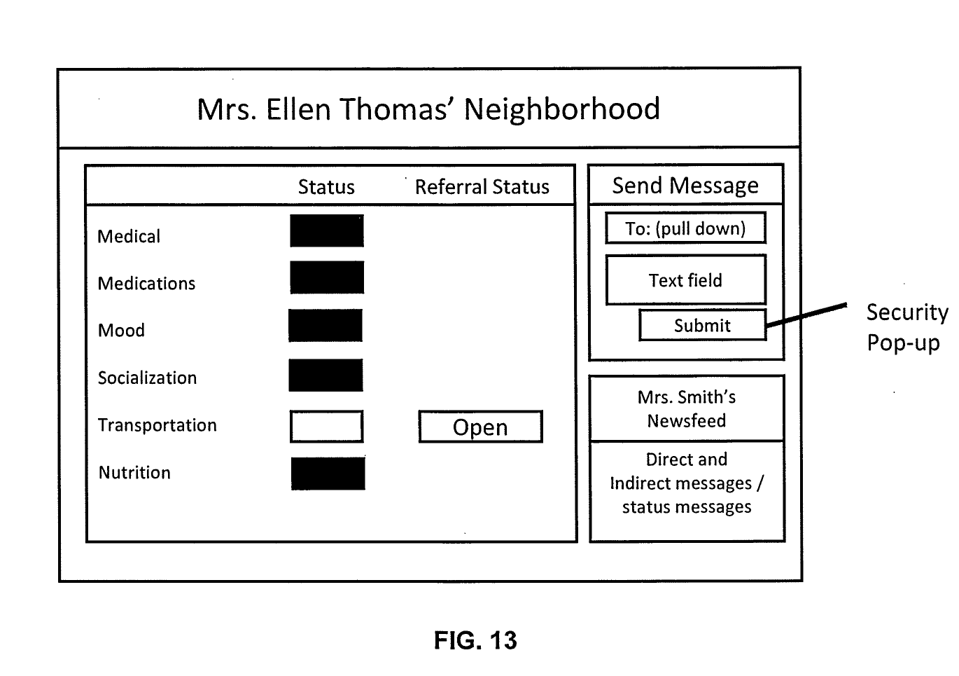

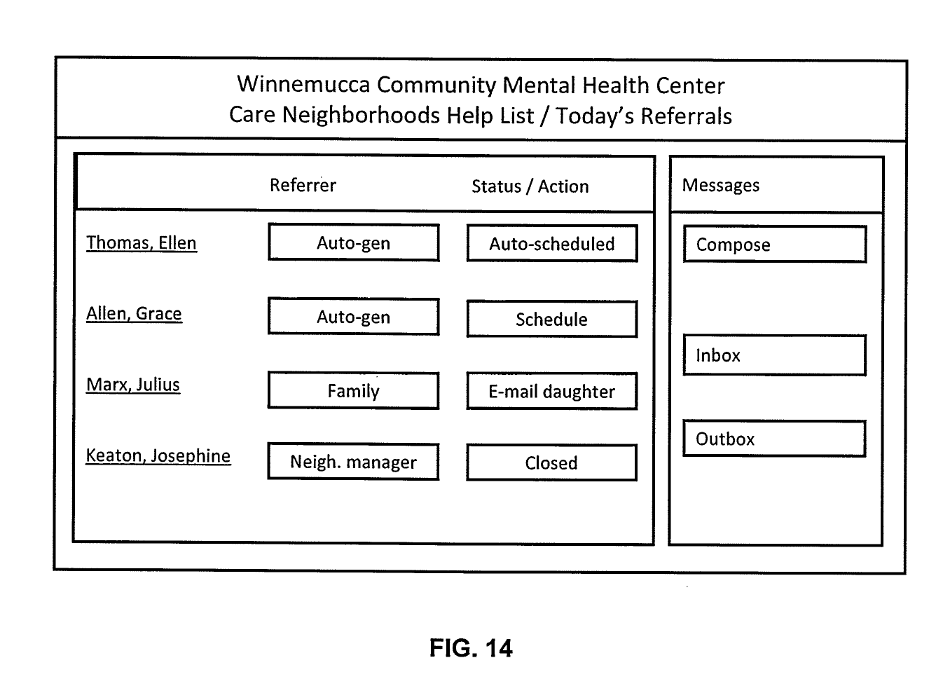

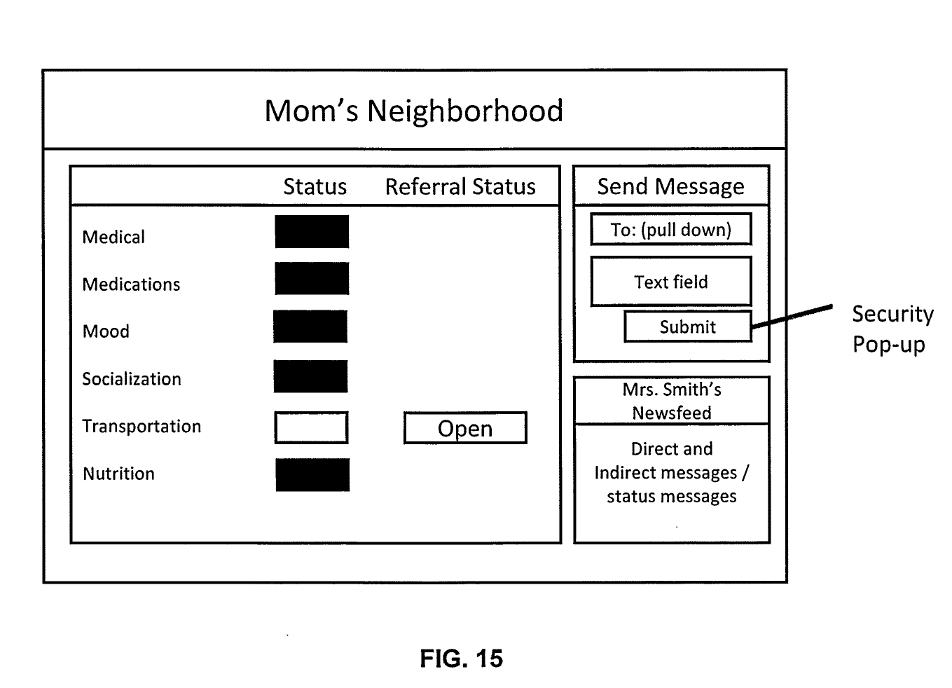

Referral can be carried out with the assistance of various management views as illustrated in FIG. 12-15, FIG. 12 shows a management interface for a health coordinator that sees the needs of a number of patients and referral provided by the network. At the individual patient level, the healthcare coordinator can check the status of each referral and correspond with the patient or healthcare providers (FIG. 13). Each healthcare provider is also able to see the referrals made to the provider and can conduct needed correspondence with the patients or the care coordinators (FIG. 14). The patient or the patient delegate, at a different view, can also check status and manage such referrals (FIG. 15).

A scheduling module can further be included to supplement the survey and referral modules, or to function independently. The scheduling module, for instance, can schedule transportation, check up, doctor's appointment, urgent medical care, and/or pharmacy visit or pickup on behalf of the patient. The scheduling, in one aspect, is automatically triggered by survey result. In this respect, an attempt to make an appointment with a doctor can be made once the patient shows a sign of sickness. Likewise, when a successful appointment or a referral is made, the scheduling module can schedule transportation for the visit. In one aspect of any of such embodiments, the healthcare coordinator and/or delegate is kept apprised of such scheduling, or the failure of doing so.

### Care Coordination and Management

The present disclosure provides systems and methods for care coordination, management, and support and health information exchange using software applications built on a social network. Such a social network can be an existing and trusted social network, such as Facebook (accessible at facebook.com). The present technology provides a mechanism for registering on an existing social network or logging in, and then drawing profile information. The social network of the present technology enables a user to establish a personal health record and for the importation and export of data from external electronic medical, health, or personal health records systems or insurance-plan-based claims systems.

Thus, the present disclosure provides virtual-care networks connecting patients, primarily with chronic illness or disability or elders, with informal family caregivers and professional caregivers—whether healthcare or aging services—via a secure social network that can be built as an application on an existing, ubiquitous social-networking platform, such as Facebook.

As a result, the present technology provides a highly scalable system for care coordination and management, particularly aimed at individuals with multiple chronic conditions and the disabled. Care coordination and management is intended to address what are typically multiple needs for these individuals, as well as coordination of an array of healthcare (primary care, specialties, mental health, pharmacy) and social (Meals on Wheels, adult daycare). Communication between these organizations in a given geographical area has typically been telephonic—a process that can be inefficient and excessively resource intensive. While many healthcare organizations have introduced electronic record-keeping systems, these systems generally do not interface with one another. The use of an computer network-based social network is intended to use a ubiquitous existing platform to create a care coordination and management system that can, in effect, ‘end run’ around the interoperability requirement

Therefore, the present technology serves as a system for interactive, personalized, automated assessment and patient activation in the process of managing their chronic conditions and/or disability through ‘healthbots’ that deliver personalized prevention interventions to support individuals in staying healthier and thus preventing complications of their chronic illness that may result in a hospital admission or institutionalization.

Further, the present technology serves as a form of highly searchable electronic health record (EHR)/personal health record (PHR) through the aggregation of so-called status updates' by the patients themselves (or a designated formal or informal caregiver) and ‘wall postings’ from family or professional caregivers about a patient's status, as well as readings (such as weight) from biometric devices.

Accordingly, one aspect of the disclosure provides a computer-implemented method for sharing healthcare information in a social network, the social network comprising a patient, a delegate and a healthcare service, wherein the delegate has authorization from the patient to (1) access authorized information and/or (2) communicate with the healthcare service on behalf of the patient, the method comprising receiving from the patient or the delegate a request to share data; retrieving the data; determining one or more members of the social network with which the data can be shared based on (a) the type of the data, (b) the patient's privacy setting on the data and/or (c) the patient's authorization to the members concerning the data; and sharing the data with the members of the social network.

Also provided is a computer program product for sharing healthcare information in a social network, the social network comprising a patient, a delegate and a healthcare service, wherein the delegate has authorization from the patient to (1) access authorized information of the patient and/or (2) communicate with healthcare service on behalf of the patient, the computer program product comprising a computer-readable non-transitory medium containing executable program code, when executed, receiving from the patient or the delegate a request to share data; retrieving the data; determining one or more members of the social network with which the data can be shared based on (a) the type of the data, (b) the patient's privacy setting on the data and/or (c) the patient's authorization to the members concerning the data; and sharing the data with the members of the social network.

Likewise, methods and systems are provided for a healthcare service to share information over the social network. In one aspect, the information is shared with relevant patients. In another aspect, the information is shared with those patients' delegates.

As described above, sharing of any private information, such as PHI, over the social network is managed so as to be in compliance with by local, state and federal law and regulation.

Data to be shared by the patient or the delegate can directly entered or retrieved from an external source. Direct date entry can be made on a computer, a handheld device such as a smart phone, a tablet, or even a regular phone, without limitation. The data entry, in another aspect, can be from a personal medical device as well, such as a blood glucose meter, an electronic thermometer, or a blood pressure monitor.

In another aspect, the data can be retrieved from an external system, such as an electronic medical record maintained by a hospital, an insurance company, or even a medical history card possessed by the patient or the patient's delegate.

Sharing of information in a social network can be carried out with any methods known in the art. In one aspect, the information is archived on the network server associated with a list of members that have access to it. When the members log on to the social network, such information will be viewable to the members. In another aspect, the information is transmitted to all members that can have access to the information. The push can be by email, text messaging, phone call etc.

When the data are shared with appropriate members on the social network, needed care or support can be coordinated. In one aspect, the data comprise measurements of the patient's health condition, request for analysis and/or request for medical attention or advice. The healthcare services receiving the data and the request then can review the data and provide care or advice as seen suitable. Thus, in one aspect, the network receives information from a health service and transmits the information to the patient or the patient's delegate.

### Patient Networks and Other Sub-Networks

Within a social network as described in the present disclosure, members can form sub-networks for facilitating information sharing among the members in the sub-networks. In one aspect, the social network comprises sub-networks based on location and/or type of diseases or conditions.

One example of a sub-network is a patient network. As illustrated in FIG. 1, the patient network consists of patients P1, P6, P7 and P8. The network may be location based, so that the patients can share information about location of nearby healthcare services, among others. In another aspect, the network may be disease specific. For instance, all patients in the network suffer from diabetes and they can share information on improving their conditions.

Another example of sub-network is a healthcare service network which includes, in one aspect, all services responsible for a patient, or providing services in a specific disease area. Such a sub-network would improve care efficiency and/or cross-training.

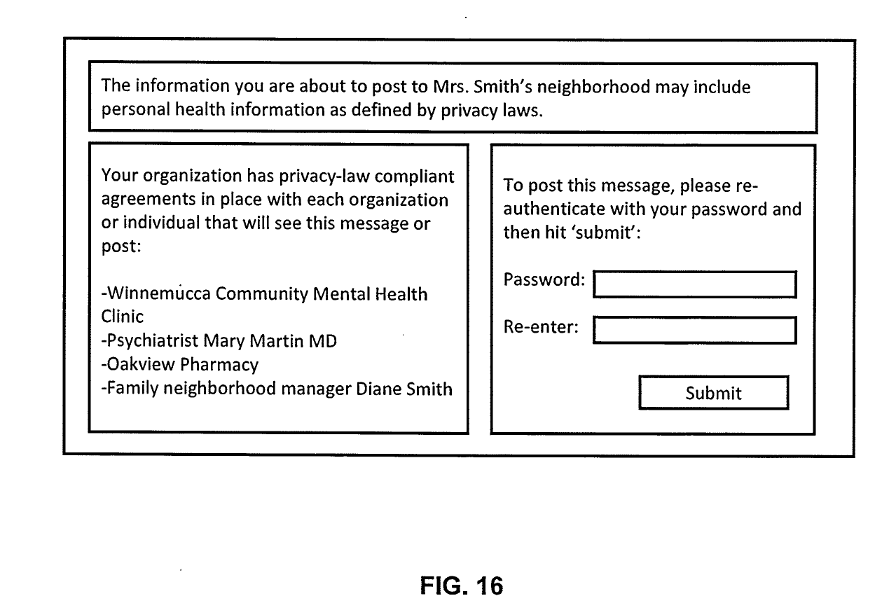

It is noted, whether throughout the social network or within a sub-network, privacy can be enforced with the present technology. For example, when a network member posts a message on the network, the member is reminded of the privacy concern, and when necessary, is required to authenticate itself before posting (FIG. 16).

### Improved Care and Care Coordination

A unique advantage of the present technology is that a large amount of healthcare related information is shared over the social network with proper privacy protection. The wealth of such information may enable care providers to improve their services. For example, a physician or other care professional, depending on their permitted access to such data, can review a patient's medical history in view of the medical history of other patients (both on an individual or population base) within the same geographical area, and may be able to take into consideration location or cultural influence at that location.

The systems and methods of the present disclosure, in one aspect, further includes software applications and associated care-management automated interactive content to assess individuals at a frequency to be determined by the care manager as a means of both monitoring them for potential problems while providing a foundation of self-management support.

Moreover, analytic software can be further included for decision support, largely to triage the alerts and establish a care-management worklist and workflow based on targeting efforts toward patients that have been identified as currently having a problem rather than waiting until the conditions worsen.

### Computer Network

It will be appreciated by the knowledgeable reader that the social network of the present disclosure can be implemented on any computer network. In some aspect, information exchange over the computer network is carried out through secure data communication. Methods and devices for providing secure data communication are well known in the art.

Embodiments can include program products comprising non-transitory machine-readable storage media for carrying or having machine-executable instructions or data structures stored thereon. Such machine-readable media may be any available media that may be accessed by a general purpose or special purpose computer or other machine with a processor. By way of example, such machine-readable storage media may comprise RAM, ROM, EPROM, EEPROM, CD-ROM or other optical disk storage, magnetic disk storage or other magnetic storage devices, or any other medium which may be used to store desired program code in the form of machine-executable instructions or data structures and which may be accessed by a general purpose or special purpose computer or other machine with a processor. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, logics, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed and cloud computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It should be noted that although the discussions herein may refer to a specific order and composition of method steps, it is understood that the order of these steps may differ from what is described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included. Within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

Unless otherwise defined, all technical and scientific terms used herein have the same meaning as commonly understood by one of ordinary skill in the art to which this invention belongs.

The inventions illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed.

Thus, it should be understood that although the present invention has been specifically disclosed by preferred embodiments and optional features, modification, improvement and variation of the inventions embodied therein herein disclosed may be resorted to by those skilled in the art, and that such modifications, improvements and variations are considered to be within the scope of this invention. The materials, methods, and examples provided here are representative of preferred embodiments, are exemplary, and are not intended as limitations on the scope of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

In addition, where features or aspects of the invention are described in terms of Markush groups, those skilled in the art will recognize that the invention is also thereby described in terms of any individual member or subgroup of members of the Markush group.

All publications, patent applications, patents, and other references mentioned herein are expressly incorporated by reference in their entirety, to the same extent as if each were incorporated by reference individually in case of conflict, the present specification, including definitions, will control.

It is to be understood that while the disclosure has been described in conjunction with the above embodiments, that the foregoing description and examples are intended to illustrate and not limit the scope of the disclosure. Other aspects, advantages and modifications within the scope of the disclosure will be apparent to those skilled in the art to which the disclosure pertains.

1. A computer-implemented system for coordination or management of healthcare wherein the system is configured to communicate with a social network comprising (a) a patient and (b) a healthcare coordinator and/or a healthcare provider, the system comprising a survey module configured to present to the patient a survey to assess the patient's health condition and, based on the patient's response to the survey, alert the healthcare coordinator and/or the healthcare provider.

2. The system of claim 1, further comprising a survey question database that comprises one or more questions, each of the questions targets at one or more health conditions.

3. The system of claim 2, wherein each question is associated with one or more answers and at least one of the answers is tagged with one or more types of healthcare services.

4. The system of claim 1, wherein the survey comprises a set of questions, which set is dynamically generated.

5. The system of claim 4, wherein generation of a later question in the set is based on the patient's answer to an earlier question in the set.

6. The system of claim 1, further comprising a delegate module configured to designate another member of the social network as a patient delegate of the patient, wherein the patient delegate has authorization from the patient to access the patient's personal or medical information and/or communicate with the healthcare coordinator or the healthcare provider on behalf of the patient.

7. The system of claim 6, wherein the patient delegate is selected from a friend, a family member, a personal caretaker or a healthcare coordinator.

8. The system of any claim 1, further comprising a privacy module configured to ensure that exchange of information concerning the patient through the social network is in compliance with relevant privacy law or regulation.

9. The system of claim 8, wherein the privacy module assigns a privacy classification to a message sent from each member of the social network.

10. The system of claim 1, wherein the patient suffers from a chronic disease or condition.

11. The system of claim 1, further comprising a patient interface module configured to allow the patient to interact with the social network.

12. The system of claim 11, wherein the patient interface is includes the survey.

13. The system of claim 11, further comprising a healthcare coordinator interface configured to allow the healthcare coordinator to manage the patient.

14. The system of claim 13, wherein the healthcare coordinator interface includes health status of the patient and/or alert sent from the patient.

15. The system of claim 1, further comprising a scheduling module configured to schedule transportation, check up, doctor's appointment, urgent medical care, and/or pharmacy visit or pickup for the patient.

16. The system of claim 15, wherein the scheduling module is automatically triggered by a response to the survey.

17. The system of claim 1, further comprising an external system for collecting health information from a patient or relevant to the patient's health status.

18. The system of claim 17, wherein the external system is a measuring and/or monitoring device configured to measure one or more vital signs of the patient.

19. A computer-implemented method for sharing healthcare information in a social network, the social network comprising a patient, a delegate and a healthcare service, wherein the delegate has authorization from the patient to (1) access authorized information and/or (2) communicate with the healthcare service on behalf of the patient, the method comprising:
receiving from the patient or the delegate a request to share data;
retrieving the data;
determining one or more members of the social network with which the data can be shared based on (a) the type of the data, (b) the patient's privacy setting on the data and/or (c) the patient's authorization to the member concerning the data; and
sharing the data with the member of the social network.

20. A computer-implemented method for sharing healthcare information in a social network, the social network comprising a patient, a delegate and a healthcare service, wherein the delegate has authorization from the patient to (1) access authorized information and/or (2) communicate with the healthcare service on behalf of the patient, the method comprising:
receiving from the healthcare service a request to share data;
retrieving the data;
determining whether the delegate has authorization to receive the data based on (a) the type of the data, (b) the patient's privacy setting on the data and/or (c) the patient's authorization to the delegate concerning the data; and
sharing the data with the delegate if the delegate has authorization to receive the data.
